(19) United States
(12) Patent Application Publication
(10) Pub. No.: US 2023/0281550 A1
(43) Pub. Date: Sep. 7, 2023

(54) AI-GENERATED PLANS WITHIN MERGED USER STRUCTURES

(71) Applicant: KWIKCLICK, LLC, Murray, UT (US)

(72) Inventor: Fred Cooper, Farmington, UT (US)

(21) Appl. No.: 18/090,158

(22) Filed: Dec. 28, 2022

Related U.S. Application Data
(63) Continuation-in-part of application No. 17/868,451, filed on Jul. 19, 2022, now abandoned.
(60) Provisional application No. 63/223,304, filed on Jul. 19, 2021.

(51) Int. Cl. G06Q 10/067; G06Q 10/0637

(52) U.S. Cl. CPC G06Q 10/067; G06Q 10/0637; G06Q 50/01

(57) ABSTRACT

Disclosed herein is a system and method to any two or more MLMs to be merged into a multiline MLM system despite having different commission structures. Each member of the original MLMs is able to maintain their existing downlines without any changes. Existing MLM members may have full access to the multi-line MLM commission structure. Each type of commission may be calculated using a corresponding commission rule, which may begin in an initial state but may be changed using historical data as a guide for a learning algorithm so that the commissions generated by the rules are close to the commissions members were making in their original MLMs. Simulations of sales and commissions generated from those sales can be run a number of times on a loop, and over time the commission rules will change to bring the simulated commissions closer to expected future commissions based on historical commissions.

### CROSS-REFERENCE TO RELATED APPLICATION

The present application is a continuation-in-part of U.S. patent application Ser. No. 17/868,451 filed Jul. 19, 2022, which claims the priority benefit of U.S. provisional application No. 63/223,304 filed Jul. 19, 2021, the disclosures of which are incorporated herein by reference.

### BACKGROUND OF THE INVENTION

### 1. Field of the Invention

The present disclosure is generally related to merging multi-level marketing systems.

### 2. Description of the Related Art

MLM companies are defined by a commission structure that is multi-level, such that a commission is payed to at least one member above the member who made a sale or purchase. However, there are multiple kinds of commission structures, for example, binary, matrix, or Unilevel. The problem is that merging these companies while maintaining the integrity of the existing commission tree has been unsuccessful when the two companies do not have the same kind of commission structure. Usually when companies with a different commission structure do merge, the two commission trees are simply kept separate and retain their traits and commission rates. Therefore, members of a binary commission structure are typically compelled to continue to build that structure even if other members of the now merged company are Unilevel. If the merged company does decide to attempt to merge the commission trees, it often ends with members feeling disoriented by changes in position and can bring sudden changes in what was steady income which is very upsetting to members when the change results in a loss of income.

In order to help members transition from their old MLM to the new merged MLM, the commission rules of the new merged MLM should award all members roughly the same amount of income as they made under their original systems. Unfortunately, creating a rule that accomplishes this for all member is difficult if not impossible to do without machine learning. There is a need for existing MLM companies to merge without having to either continue to keep the companies separate or upset members by rearranging the existing commission structures.

### SUMMARY OF THE CLAIMED INVENTION

Embodiments of the present invention include systems and methods for merging two or more MLMs\into a multiline MLM system despite having different commission structures. Each member of the original MLMs is able to maintain their existing downlines without any changes. Existing MLM members may have full access to the multi-line MLM commission structure. Each type of commission may be calculated using a corresponding commission rule, which may begin in an initial state but may be changed using historical data as a guide for a learning algorithm so that the commissions generated by the rules are close to the commissions members were making in their original MLMs. Simulations of sales and commissions generated from those sales can be run a number of times on a loop, and over time the commission rules will change to bring the simulated commissions closer to expected future commissions based on historical commissions.

### BRIEF DESCRIPTIONS OF THE DRAWINGS

FIG. 1 illustrates an exemplary network environment in which a multi-level marketing merger system may be implemented.

FIG. 2A illustrates an exemplary multiline MLM user database.

FIG. 2B illustrates an exemplary multiline MLM commission structure based on the data in FIG. 2A.

FIG. 3 illustrates an exemplary multiline MLM sales database.

FIG. 4 illustrates an exemplary multiline MLM commission module.

FIG. 5 illustrates an exemplary multiline MLM commission rules database.

FIG. 6 illustrates an exemplary multiline MLM commission database.

FIG. 7 illustrates an exemplary multiline MLM additional line module.

FIG. 8 illustrates an exemplary multiline MLM merger module.

FIG. 9 illustrates an exemplary unilevel MLM unilevel base module.

FIG. 10A illustrates an exemplary unilevel MLM unilevel user database.

FIG. 10B illustrates an exemplary unilevel MLM commission structure based on the data in FIG. 10A.

FIG. 11 illustrates an exemplary matrix MLM matrix base module.

FIG. 12A illustrates an exemplary matrix MLM matrix user database.

FIG. 12B illustrates an exemplary matrix MLM commission structure based on the data in FIG. 12A.

FIG. 13 illustrates an exemplary binary MLM binary base module.

FIG. 14A illustrates an exemplary binary MLM binary user database.

FIG. 14B illustrates an exemplary binary MLM commission structure based on the data in FIG. 14A.

FIG. 15 illustrates an exemplary merged MLM user data collection module.

FIG. 16A illustrates an exemplary merged MLM merged user database.

FIG. 16B illustrates an exemplary merged MLM commission structure based on the data in FIG. 16A.

FIG. 17 illustrates an exemplary merged MLM simulated sales database.

FIG. 18 illustrates an exemplary merged MLM commission simulation module.

FIG. 19 illustrates an exemplary merged MLM merged commission rules database.

FIG. 20 illustrates an exemplary merged MLM commission simulation database.

FIG. 21 illustrates an exemplary merged MLM commission comparison module.

FIG. 22 illustrates an exemplary merged MLM commission AI module.

### DETAILED DESCRIPTION

Embodiments of the present invention include systems and methods for merging two or more MLMs\into a multiline MLM system despite having different commission structures. Each member of the original MLMs is able to maintain their existing downlines without any changes. Existing MLM members may have full access to the multi-line MLM commission structure. Each type of commission may be calculated using a corresponding commission rule, which may begin in an initial state but may be changed using historical data as a guide for a learning algorithm so that the commissions generated by the rules are close to the commissions members were making in their original MLMs. Simulations of sales and commissions generated from those sales can be run a number of times on a loop, and over time the commission rules will change to bring the simulated commissions closer to expected future commissions based on historical commissions.

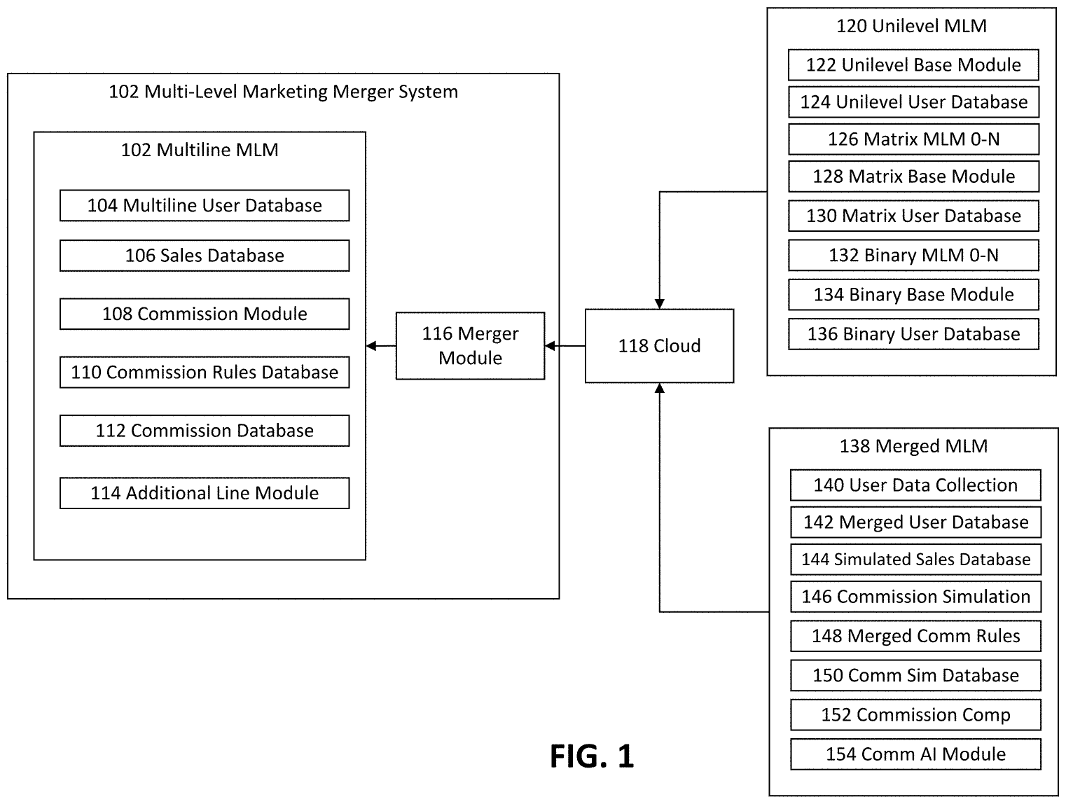

FIG. 1 illustrates an exemplary network environment 100 in which a multi-level marketing merger system may be implemented. Network environment 100 may include a multiline MLM data structure 102, which includes data regarding a distribution organization characterized by a multi-level relationship structure in which each user of the organization may be a distributor and pays commission to the user or users above them in the organization's structure, and which allows users to have an infinite amount of lines, which are users below them paying commission, and the users below those users, and so on. In an embodiment, these additional lines may only be added once the users initial lines meet a threshold volume or commission amount.

A multiline MLM multiline user database 104 may include information on user's position in the multiline MLM commission structure, who enrolled or sponsored the user in the multiline MLM 102, and how many lines the user is currently allowed.

A multiline MLM sales database 106 may include data on sales made by users, which is used by the multiline MLM commission module 108 to pay commissions to other users.

A multiline MLM commission module 108 may calculate commission based on new sales data in the multiline MLM sales database 106 and stores that commission in the multiline MLM commission database 112. In some embodiments, the multiline MLM commission module 108 may also pay users directly.

A multiline MLM commission rules database 110 may store commission rules which are used by the multiline MLM commission module 108 to determine commissions.

A multiline MLM commission database 112 may store commissions calculated by the multiline MLM commission module 108, which are then used by the multiline MLM additional line module 114 to determine if the user qualifies for an additional line. In some embodiments this data may be used by another module to pay commissions to users.

A multiline MLM additional line module 114 may determine if the user has met the threshold commission value on their existing lines based on data from the multiline MLM commission database 112, and if so, may add an additional line to the number of lines that user is allowed.

A multiline MLM merger module 116 receives data from the unilevel MLM unilevel user database 124 via the unilevel MLM unilevel base module 122, MLM matrix user database 130 via the matrix MLM matrix base module 128, and binary MLM binary user database 136 via the binary MLM binary base module 134, makes sure the data includes the relevant metrics, and sends the data to the merged MLM user data collection module 140.

The cloud or communication network 118 may be a wired and/or a wireless network. The communication network 118, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network 118 may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

A number of unilevel MLM data structures 120 may include data regarding distribution organizations characterized by a multi-level payment structure where each user of the organization is a distributor and pays commission to the user or users above them in the organization's structure, and which allows users to have an infinite amount of lines corresponding to users below them paying commission, and the users below those users, etc. until a certain depth of users is reached. For example, if user 1 is above user 2, who is above user 3, who is above user 4, who is above user 5, etc., then users 2, 3, and 4 may pay commissions to user 1, but users 5, 6, 7, etc. do not pay commissions to user 1.

A unilevel MLM unilevel base module 122 extracts data from the unilevel MLM unilevel user database 124 and sends that data to the multiline MLM merger module 116 to be stored in the multiline MLM multiline user database 104.

A unilevel MLM unilevel user database 124 includes information on user's position in the unilevel MLM 120 commission structure, who enrolled or sponsored the user in the unilevel MLM 120, how many lines the user currently has, and historical commissions data for that user.

A number of matrix MLMs 126 are distribution organizations characterized by a multi-level payment structure where in each user of the organization is a distributor and pays commission to the user or users above them in the organization's structure, and which allows users to have an fixed amount of lines, which are users below them paying commission, and the users below those users, etc. until a certain depth of users is reached. For example, if user 1 is above user 2, who is above user 3, who is above user 4, who is above user 5, etc., then users 2, 3, and 4 may pay commissions to user 1, but users 5, 6, 7, etc. do not pay commissions to user 1; and user 1 may only have a limited number of users directly below them, for example, 5.

A matrix MLM matrix base module 128 extracts data from the matrix MLM matrix user database 130 and sends that data to the multiline MLM merger module 116 to be stored in the multiline MLM multiline user database 104.

A matrix MLM matrix user database 130 includes information on user's position in the matrix MLM 126 commission structure, who enrolled or sponsored the user in the matrix MLM 126, how many lines the user currently has, and historical commissions data for that user.

A number of binary MLMs 132 are distribution organizations characterized by a multi-level payment structure where in each user of the organization is a distributor and pays commission to the user or users above them in the organization's structure, and which allows users to have only 2 lines, which are users below them paying commission, and the users below those users, etc. for an unlimited amount of depth.

A binary MLM binary base module 134 extracts data from the binary MLM binary user database 136 and sends that data to the multiline MLM merger module 116 to be stored in the multiline MLM multiline user database 104.

A binary MLM binary user database 136 includes information on user's position in the binary MLM 132 commission structure, who enrolled or sponsored the user in the binary MLM 132, and historical commissions data for that user.

A merged MLM 138 is a new entity created from the merger of at least two MLMs with different structures, for example, the merger of a unilevel MLM 120 and a binary MLM 132, of unilevel MLM 120, matrix MLM 126, and binary MLM 132, or of 15 matrix MLMs 126 and one binary MLM 132. The merged MLM 138 receives data from the multiline MLM 102 in order to create an organizational structure that includes the members of the MLMs that have been merged. In some embodiments, the merged MLM 138 may not exist at the same time as some of the other components of this system, in which case the data on users may be temporarily or permanently stored in a database by the multiline MLM 102.

In some embodiments, the merged MLM 138 may be the same legal entity as one of the MLMs being merged. For example, a binary MLM 132 may acquire a unilevel MLM 120 and convert to a multiline structure in order to absorb the members of the unilevel MLM 120, in which case the binary MLM 132 and merged MLM 138 are the same company or organization from a legal perspective.

A merged MLM user data collection module 140 receives user data from the multiline MLM merger module 116, which is then stored in the merged MLM merged user database 142 and includes data on users from the other MLMs that were merged to create the merged MLM 138.

A merged MLM merged user database 142 includes information on user's position in the merged MLM 138 commission structure, who enrolled or sponsored the user in the merged MLM 138 or one of the MLMs that was eventually merged into the merged MLM 138, the number of lines that user is allowed under a multiline commission structure, and both pre-merger and post-merger commission data for that user.

A merged MLM simulated sales database 144 includes simulated future sales that will be used by the merged MLM commission simulation module 146 to simulate commissions being paid up the commission tree. In an embodiment, this database is filled with data by another module.

A merged MLM commission simulation module 146 simulates commissions being paid to users so that the simulated commission data can be compared to the historical commission data, the data is stored in the merged MLM commission simulation database 150.

A merged MLM merged commission rules database 148 stores commission rules which are used by the merged MLM commission simulation module 146 to determine commissions.

A merged MLM commission simulation database 150 stores commissions calculated by the merged MLM commission simulation module 146.

A merged MLM commission comparison module 152 compares the simulated commission data stored in the merged MLM commission simulation database 150 to the historical commission data stored in the merged MLM merged user database 142 in order to measure how much different commissions would be under the current iteration of the commission rules compared to historical commissions across all users.

A merged MLM commission AI module 154 alters the current commission rules based on the results of the merged MLM commission comparison module 152, after several iterations of alterations the commission's rules should distribute commission in a manner that brings future commissions in line with historical commissions.

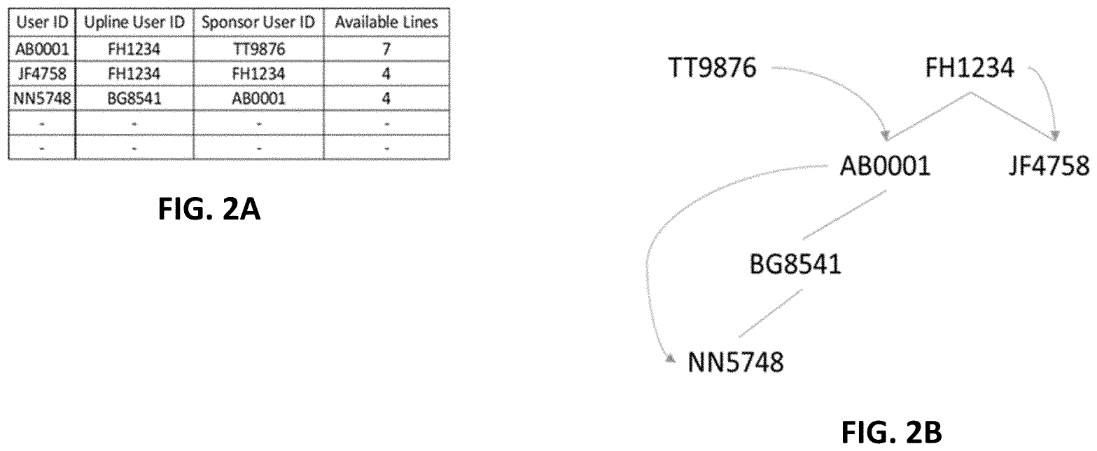

FIG. 2A illustrates an exemplary multiline MLM user database 104, and FIG. 2B illustrates an exemplary multiline MLM commission structure based on the data in FIG. 2A. The multiline MLM database may includes a user ID (e.g., AB0001), information on user's position in the multiline MLM 102 commission structure, the user ID of the user above them in the commission structure (e.g., FH1234), who enrolled or sponsored the user in the multiline MLM 102 (e.g., user ID TT9876), and how many lines the user is currently allowed (e.g., 7). Users are assigned a default number of lines when they join the multiline MLM 102. Users that were merged from another MLM (e.g., unilevel MLM) will come into the multiline MLM 102 with at least the number of lines they had under their old MLM structure. In an embodiment, the default number of lines is 4. FIG. 2B shows a possible commission structure wherein the straight lines indicate an upline/downline relationship between two users and a curved, arrowed line indicates that the user the arrow points to was sponsored by the user the line originates from, more lines and users may exist than are shown, element 200.

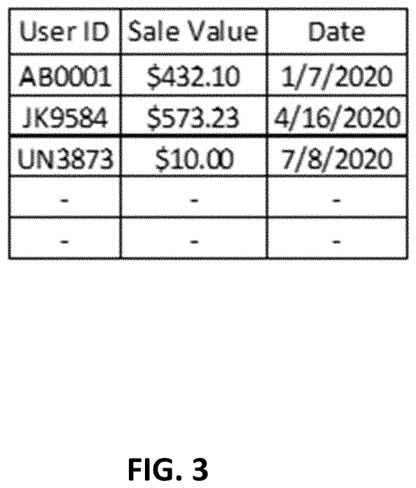

FIG. 3 illustrates an exemplary multiline MLM sales database 106. The multiline MLM sales database 106 includes data on sales made by users, which includes a user ID (e.g., AB0001), a sale value (e.g., $432.10), and a transaction date (e.g., Jan. 7, 2020), etc., for use by the multiline MLM commission module 108 to pay commissions to other users. In some embodiments, the database may include more sales data such as the seller's ID if applicable, item IDs of the items sold, volume sold, payment method and data, etc.

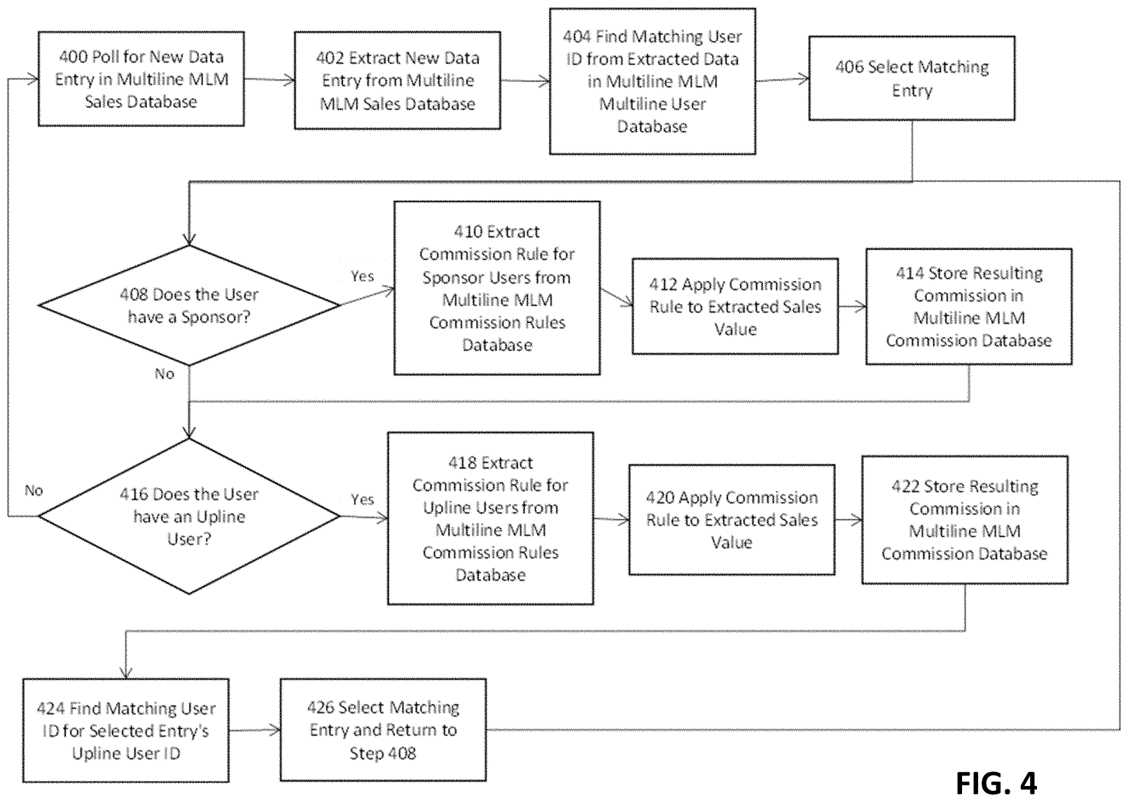

FIG. 4 illustrates an exemplary multiline MLM commission module 106. The process begins with the multiline MLM commission module 108 polling for a new data entry in the multiline MLM sales database 106, for example, when a sale is made by a user at step 400.

The multiline MLM commission module 108 extracts the new data entry from the multiline MLM sales database 106 which includes at least a user ID, sales value, and date at step 402.

The multiline MLM commission module 108 searches for a User ID in the multiline MLM multiline user database 104 that matches the user ID extracted from the multiline MLM sales database 106. For example, if the extracted user ID had a value of “AB0001,” then the multiline MLM commission module 108 will search the multiline MLM multiline user database 104 for a value of “AB0001” in the “User ID” category.

The multiline MLM commission module 108 selects the entry in the multiline MLM multiline user database 104 with a matching user ID value at step 406.

In step 408, the multiline MLM commission module 108 determines if the user has a sponsor by checking the entry for a value in the “Sponsor User ID” category. If there is no value, or the value does not correspond to a user ID, then the multiline MLM commission module 108 will skip to step 416.

If there is a value that corresponds to a user ID in the “Sponsor User ID” category, the multiline MLM commission module 108 extracts the commission rule from the multiline MLM commission rule database 110 for sponsor users at step 410. The multiline MLM commission module 108 applies the extracted commission rule to the sales value extracted from the multiline MLM sales database 106. For example, if the rule is 10% commission for sponsors and the sales value is $300, then $300 will be multiplied by 10% to get $30 which is the commission payable to the sponsor.

In an embodiment, the sponsor may be paid directly by the multiline MLM commission module 108 after this step at step 412. The multiline MLM commission module 108 stores the resulting commission in the multiline MLM commission database 112 along with the user ID of the sponsoring user to be paid, the user ID of the sponsored user, the commission type, sponsor, and the date extracted from the multiline MLM sales database 106.

In some embodiments, the date may be changed to reflect a delay in the processing of the commission or payment of the commission at step 414. The multiline MLM commission module 108 determines if the user has an upline user by checking the entry for a value in the “Upline User ID” category.

If there is no value or the value does not correspond to a user ID, then the multiline MLM commission module 108 will return to polling for a new data entry in the multiline MLM sales database 106 at step 416.

If there is a value that corresponds to a user ID in the “Upline User ID” category, the multiline MLM commission module 108 extracts the commission rule from the multiline MLM commission rule database 110 for upline users at step 418. The multiline MLM commission module 108 applies the extracted commission rule to the sales value extracted from the multiline MLM sales database 106. For example, if the rule is 10% commission for upline users and the sales value is $300, then $300 will be multiplied by 10% to get $30, which is the commission payable to the upline user. In some embodiments, users may receive a different commission based on how many levels upline they are from the user who made the sale. For example, the upline user of the upline user may earn 5% commission, and next upline user may earn 1% commission.

In an embodiment, the upline user may be paid directly by the multiline MLM commission module 108 at step 420. The multiline MLM commission module 108 stores the resulting commission in the multiline MLM commission database 112 along with the user ID of the upline user to be paid, the user ID of the downline user, the commission type (e.g., upline), and the date extracted from the multiline MLM sales database 106. In some embodiments, the date may be changed to reflect a delay in the processing of the commission or payment of the commission at step 422.

The multiline MLM commission module 108 then searches the multiline MLM multiline user database 104 for an entry where the user ID in the “User ID” category matches the user ID in the “Upline User ID” category of the currently selected entry at step 424.

The multiline MLM commission module 108 selects the entry with the matching user ID value as the new selected entry and returns to step 408 at step 426.

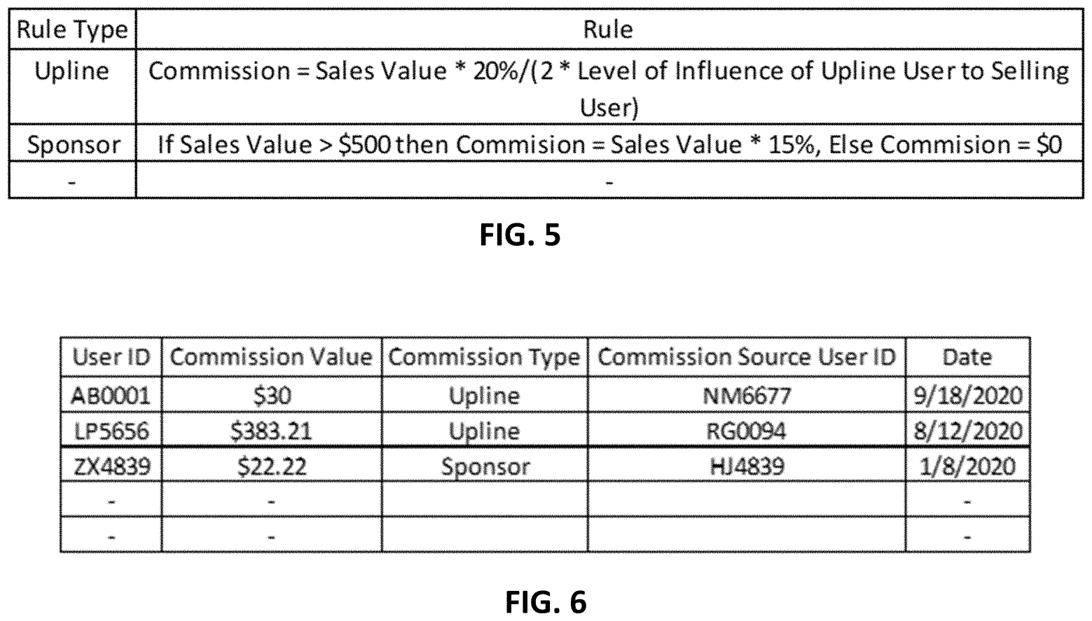

FIG. 5 illustrates an exemplary multiline MLM commission rules database 110. The multiline MLM commission rules database 110 includes commission rules which are used by the multiline MLM commission module 108 to determine commissions. Commission rules can be complex or simple, but will often involve a mathematical calculation. For example, a rule may dictate that commissions for upline users are 10% of the sales value, divided by two for each level above the selling user, meaning that for a $100 dollar sale, the upline user will receive $10 the user above them, or 2nd level of influence from the user who made the sale will receive $5, the user above them will receive $2.50, etc. In another example, the rule may dictate that the commission for sponsors is 15% of the sale but only if the sale is over $500; otherwise no commission is paid.

The database also includes the type of rule (e.g., “Sponsor”), which indicates that the rule should be used to calculate commissions for sponsors. In some embodiments, multiple rules may exist for one rule type. For example, one rule may apply to sponsors that are also somewhere upline of the user who made the sale, while a different sponsor rule may apply if the sponsor is cross-line, meaning they are not anywhere upline of the user who made the sale.

FIG. 6 illustrates an exemplary multiline MLM commission database 112. The multiline MLM commission database 112 includes commissions calculated by the multiline MLM commission module 108, which are then used by the multiline MLM additional line module 114 to determine if the user qualifies for an additional line. In some embodiments, this data may be used by another module to pay commissions to users, which comprises at least a user ID (e.g., AB0001), a commission value (e.g., $30), the type of commission (e.g., downline), the user ID of the user the commission came from (e.g., NM66770, and a date (e.g., Sep. 18, 2020). If the commission came from a sale made somewhere in a user's downline, then the commission will be considered to come from the immediately downline user. In other embodiments, the commission may be recorded as coming from the selling user.

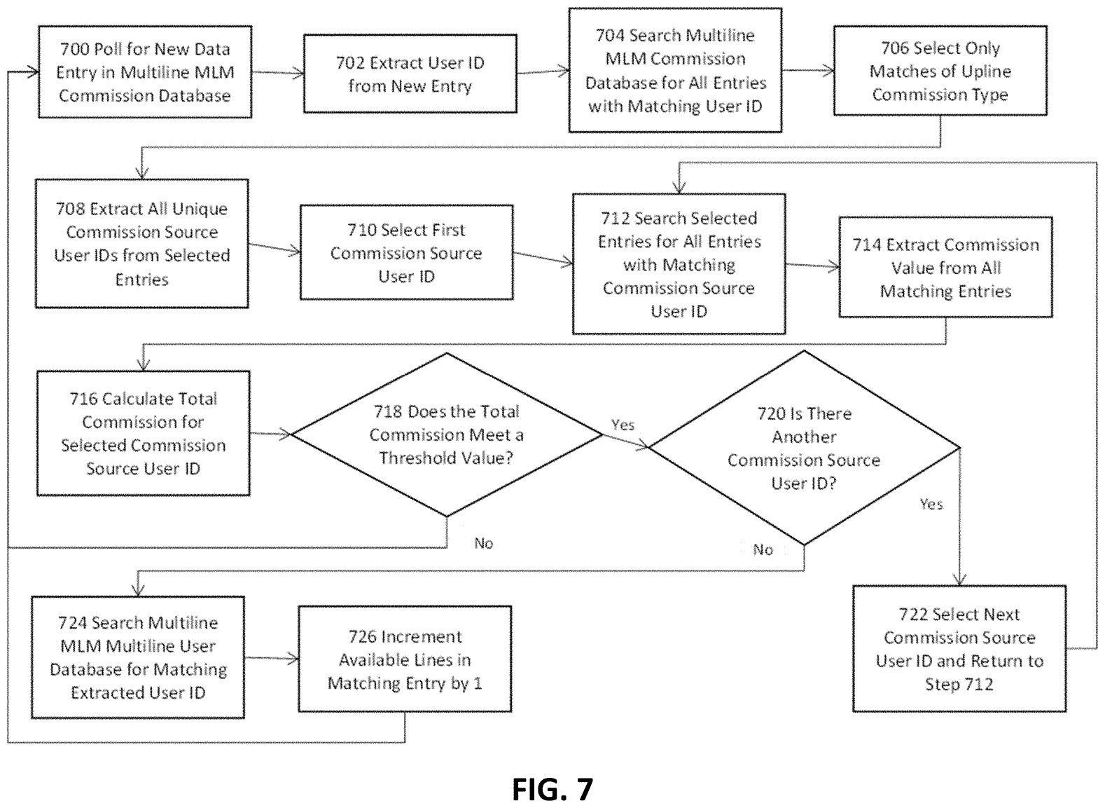

FIG. 7 illustrates an exemplary multiline MLM additional line module 114. The process begins with the multiline MLM additional line module 114 polling for a new data entry in the multiline MLM commission database 112 at step 700.

The multiline MLM additional line module 114 extracts the user ID from the User ID category in the new data entry (e.g., AB0001) at step 702.

The multiline MLM additional line module 114 searches the multiline MLM commission database 112 for all entries that also have the extracted user ID in the User ID category, which is data on all the commissions that have been paid to that user at step 704.

The multiline MLM additional line module 114 selects all the matching entries that also have “upline” in the Commission Type category at step 706.

The multiline MLM additional line module 114 extracts all the user IDs in the Commission Source User ID category of the entries, ignoring repeats, each of these user IDs corresponds to a user that is directly downline of the user who's user ID was extracted from the new data entry, and therefore each correspond to a line. In some embodiments, lines that have not yet made sales may be accounted for by creating a null or nominal commission upon creation. For example, if user AB0001 places user CD0002 in their immediate downline, a record may be recorded in the multiline MLM commission database 112 for $0.01 or $0.00 so that CD0002 is recognized as the start of one of AB0001's downlines at step 708.

The multiline MLM additional line module 114 selects the first of the extracted Commission Source User IDs, first may be determined by, for example, alphabetical order or most recent commission at step 710.

The multiline MLM additional line module 114 searches the entries selected in step 706 for all entries that match the commission source user ID selected in the Commission Source User ID category, which will find all the entries that correspond to commissions made by a single line at step 712.

At step 714, the multiline MLM additional line module 114 extracts the commission value in the Commission Value Category for each matching entry. In some embodiments, the commissions are further filtered by a time frame. For example, only commission values from commissions made in the last month will be extracted.

The multiline MLM additional line module 114 totals the extracted commission values by adding them all together to get the total commission from that line at step 716. The multiline MLM additional line module 114 determines if the total commission calculated meets a threshold value, the threshold value is a value that all lines meet before a user is allowed to have a new line. For example, if the user has 7 lines, each line has made over $1000 in commission, and the threshold value is $1000, then the user will be allowed to create an 8th line. The threshold value can be fixed or variable, in an embodiments the threshold value is stored in a database and retrieved by the multiline MLM additional line module 114. If the total commission calculated fails to meet the threshold value, then the user cannot receive a new line because all lines meet the threshold value.

The multiline MLM additional line module 114 will return to polling for a new data entry in the multiline MLM commission database 112 at step 718.

If the total commission calculated meets the threshold value, the multiline MLM additional line module 114 determines if there is another commission source user ID that was extracted in step 708 at step 720.

If there is another commission source user ID, the multiline MLM additional line module 114 selects the next commission source user ID and returns to step 712 at step 722.

If there is not another commission source user ID, the multiline MLM additional line module 114 searches the multiline MLM multiline user database 104 for an entry that matches the user ID extracted from the new entry in step 702 in the User ID category at step 724.

At step 726, the multiline MLM additional line module 114 increments the number in the Available Lines category of the matching entry by 1, which allows the user to create one additional line. In some embodiments, the number in the Available Lines category of the matching entry may be changed in another way, for example, increased by 2, multiplied by 1.2 and rounded to the nearest whole number, squared, etc.

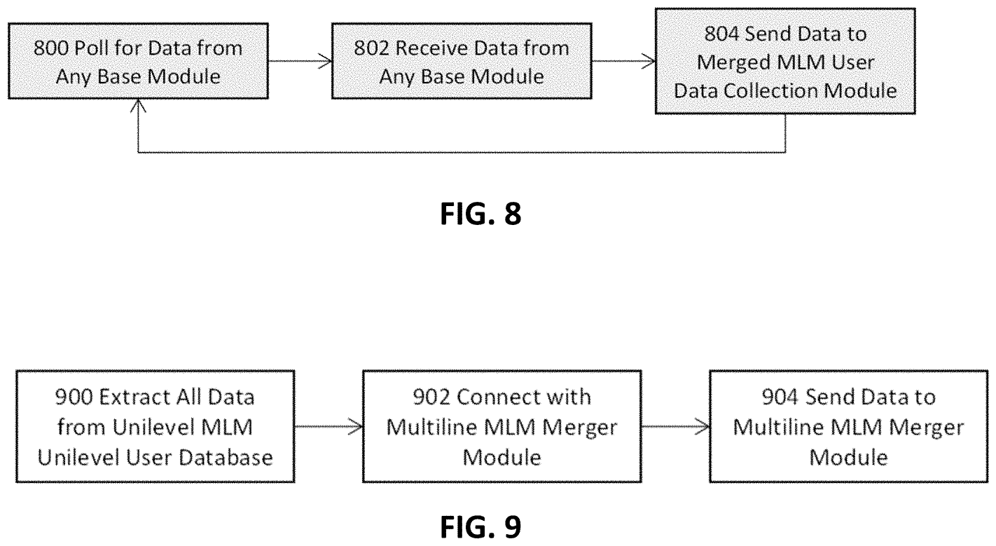

FIG. 8 illustrates an exemplary multiline MLM merger module 116. The process begins with the multiline MLM merger module 116 polling for data from the unilevel MLM unilevel base module 122, matrix MLM matrix base module 128, or binary MLM binary base module 134. This data is extracted by the Base Module of each type of MLM from the respective database of user data at step 800.

At step 802, the multiline MLM merger module 116 receives data from the unilevel MLM unilevel base module 122, matrix MLM matrix base module 128, or binary MLM binary base module 134 which includes a user ID (e.g., AB0001), information on user's position in the multiline MLM 102 commission structure via the user ID of the user above them in the commission structure (e.g., FH1234), who enrolled or sponsored the user in the multiline MLM 102 (e.g., user ID TT9876), and how many lines the user currently has in the unilevel MLM 120 (e.g., 7). In some embodiments, where the number of lines is restricted, then the number of lines may not be included with each user but sent as one value. For example, a binary MLM 134 may be assumed to allow 2 lines for each user, and a matrix MLM 126 may have a known maximum number of lines (e.g., 5), which is already accounted for by the system or sent to the multiline MLM merger module 116 alongside the user data.

At step 804, the multiline MLM merger module 116 sends the data to the merged MLM user data collection module 140 to be stored in the merged MLM merged user database 142. In an embodiment, user data without a number of lines will be set to the default value. For example, data from a binary MLM 132 may not include data for the amount of lines, because all members of a binary MLM 132 may have 2 available lines, in which case the data will be amended to include the default number of lines that would be assigned to a new member of the merged MLM 138. In an embodiment, if the number of lines a user has is less than the default value, it will be set to the default value. In an embodiment, the default value is 4 lines.

FIG. 9 illustrates an exemplary unilevel MLM unilevel base module 122. The process begins with the unilevel MLM unilevel base module 122 extracts all the data stored in the unilevel MLM unilevel user database 124 at step 900.

The unilevel MLM unilevel base module 122 connects with the multiline MLM merger module 116 through the 118 Cloud or Internet, via a physical connection, or by any other method of transferring data at step 902.

The unilevel MLM unilevel base module 122 sends the data extracted from the unilevel MLM unilevel user database 124 to the multiline MLM merger module 116 at step 904.

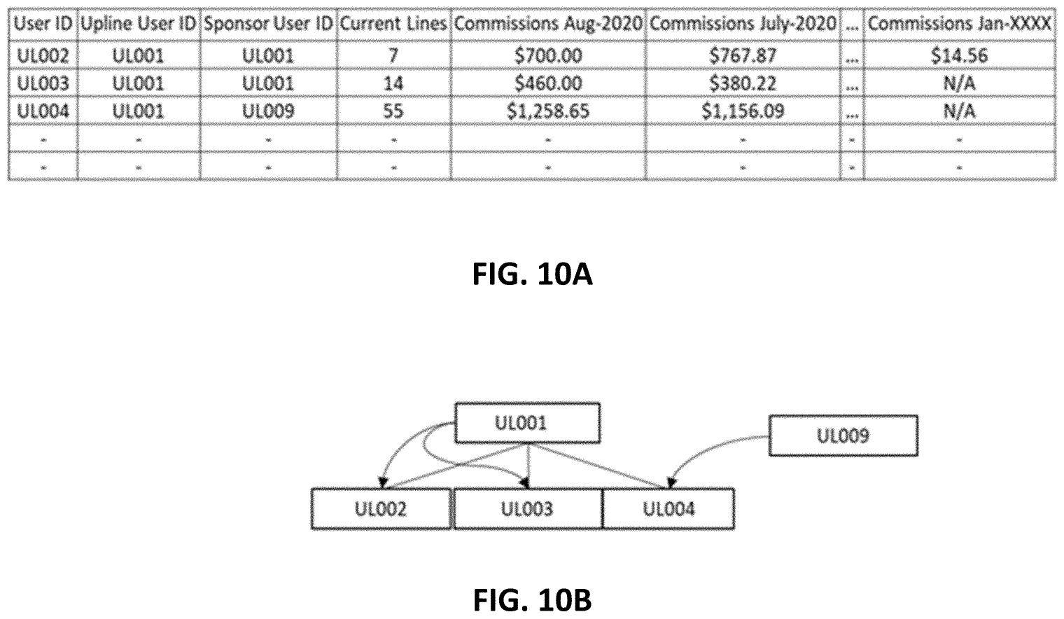

FIG. 10A illustrates an exemplary unilevel MLM unilevel user database 124. The unilevel MLM unilevel user database 124 includes information on user's position in the unilevel MLM 120 commission structure, who enrolled or sponsored the user in the unilevel MLM 120, and how many lines the user currently has, which includes a user ID (e.g., UL002), information on user's position in the multiline MLM 102 commission structure, the user ID of the user above them in the commission structure (e.g., UL001), who enrolled or sponsored the user in the multiline MLM 102 (e.g., user ID UL009), how many lines the user currently has within the existing unilevel MLM 120 (e.g., 7), and historical commissions data (e.g., $700 for the month of August 2020).

FIG. 10B illustrates an exemplary unilevel MLM commission structure based on the data in FIG. 10A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

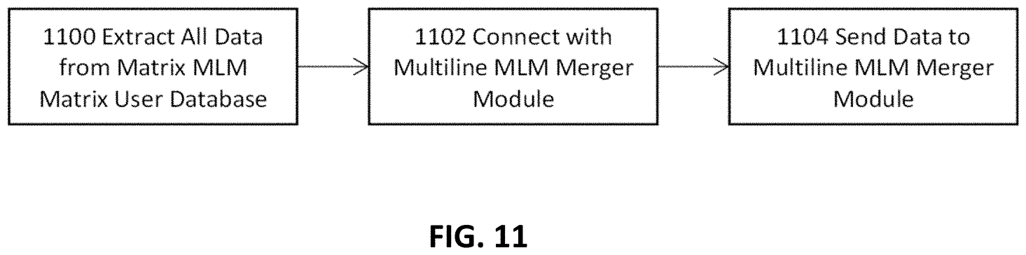

FIG. 11 illustrates an exemplary matrix MLM matrix base module 128. The process begins with the matrix MLM matrix base module 128 extracts all the data stored in the matrix MLM matrix user database 130 at step 1100.

The matrix MLM matrix base module 128 connects with the multiline MLM merger module 116 through the cloud or Internet 118, via a physical connection, or by any other method of transferring data at step 1102.

The matrix MLM matrix base module 128 sends the data extracted from the matrix MLM matrix user database 130 to the multiline MLM merger module 116 at step 1104.

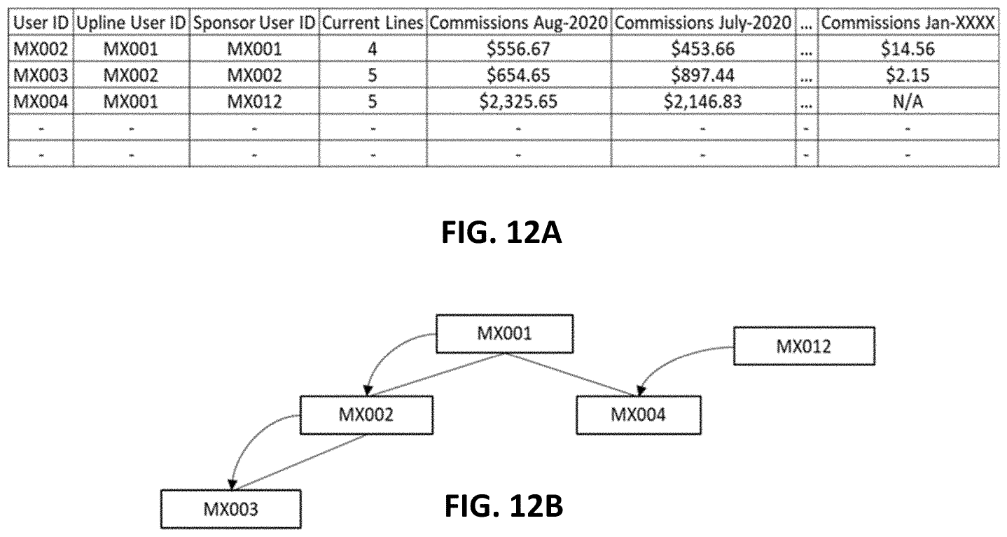

FIG. 12A illustrates an exemplary matrix MLM matrix user database 130. The matrix MLM matrix user database 130 includes information on user's position in the matrix MLM 126 commission structure, who enrolled or sponsored the user in the matrix MLM 126, and how many lines the user currently has, which includes a user ID (e.g., AB0001), information on user's position in the multiline MLM 102 commission structure, the user ID of the user above them in the commission structure (e.g., FH1234), who enrolled or sponsored the user in the multiline MLM 102 (e.g., user ID TT9876), how many lines the user currently has within the existing matrix MLM 126 (e.g., 5), and historical commissions data (e.g., $556.67 for the month of August 2020). In an embodiment, the number of lines a user currently has may not be necessary as all users under a matrix MLM 126 can be assumed to have the maximum allowed for that structure. For example, in a matrix MLM 126 where the maximum amount of lines is 5, all users will be given a default 5 lines after being merged into the multiline MLM 102

FIG. 12B illustrates an exemplary matrix MLM commission structure based on the data in FIG. 12A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

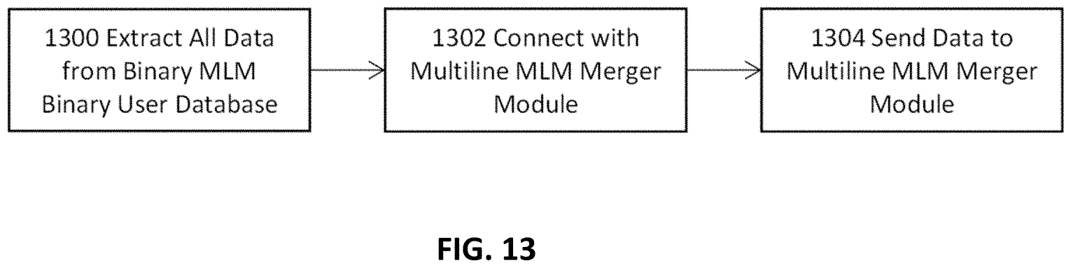

FIG. 13 illustrates an exemplary binary MLM binary base module 134. The process begins with the binary MLM binary base module 134 extracts all the data stored in the 136 Binary MLM Binary User Database at step 1300.

The binary MLM binary base module 134 connects with the multiline MLM merger module 116 through the 118 Cloud or Internet, via a physical connection, or by any other method of transferring data at step 1302.

The binary MLM binary base module 134 sends the data extracted from the binary MLM binary user database 136 to the multiline MLM merger module 116 at step 1304.

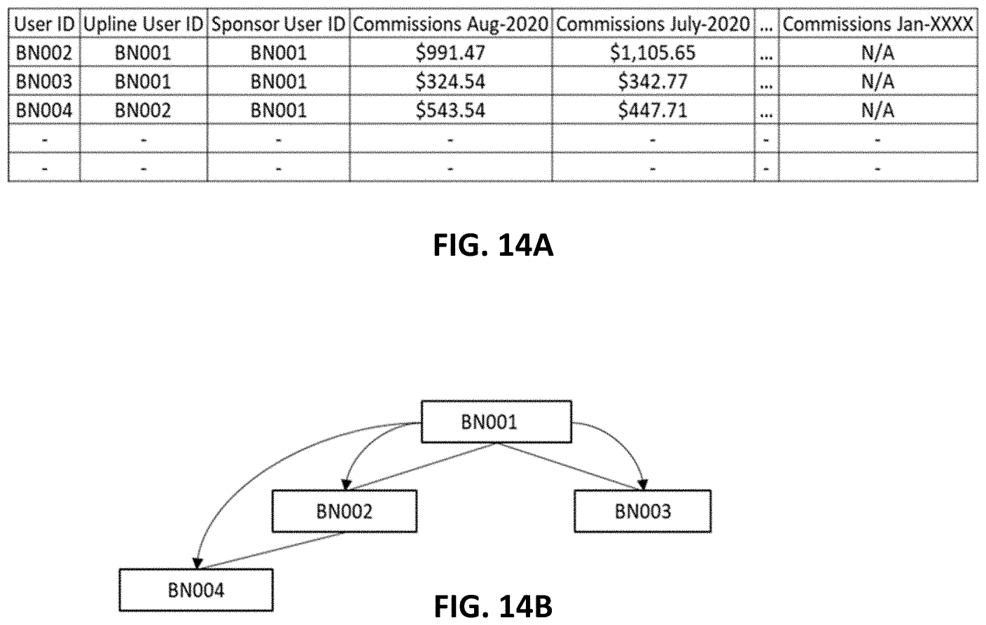

FIG. 14A illustrates an exemplary binary MLM binary user database 136. The binary MLM binary user database 136 includes information on user's position in the binary MLM 132 commission structure, who enrolled or sponsored the user in the binary MLM 136, and how many lines the user currently has, which includes a user ID (e.g., BN002), information on user's position in the multiline MLM 102 commission structure, the user ID of the user above them in the commission structure (e.g., BN001), who enrolled or sponsored the user in the multiline MLM 102 (e.g., user ID BN001), and historical commissions data (e.g., $991.47 for the month of August 2020).

FIG. 14B illustrates an exemplary binary MLM commission structure based on the data in FIG. 14A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

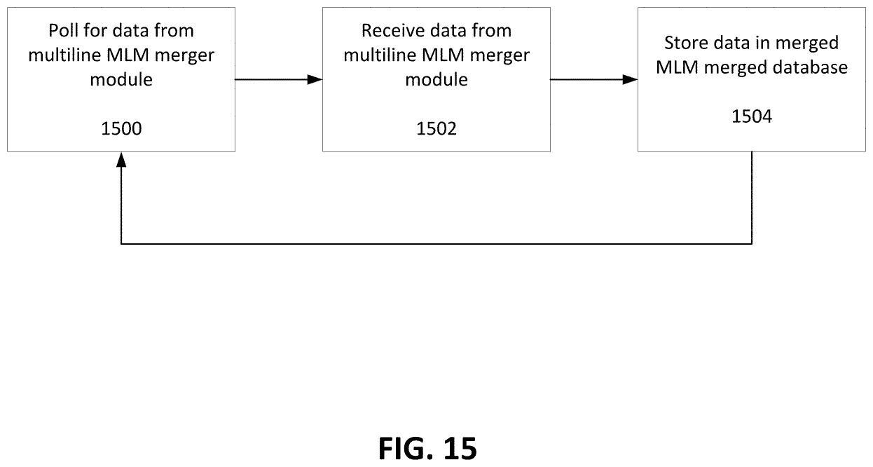

FIG. 15 illustrates an exemplary merged MLM user data collection module 140. The process begins with the merged MLM user data collection module 140 polling for data from the multiline MLM merger module 116 at step 1500.

The merged MLM user data collection module 140 receives data from the multiline MLM merger module 116 at step 1502.

The merged MLM user data collection module 140 stores the received data in the merged MLM merged user database 142 at step 1504.

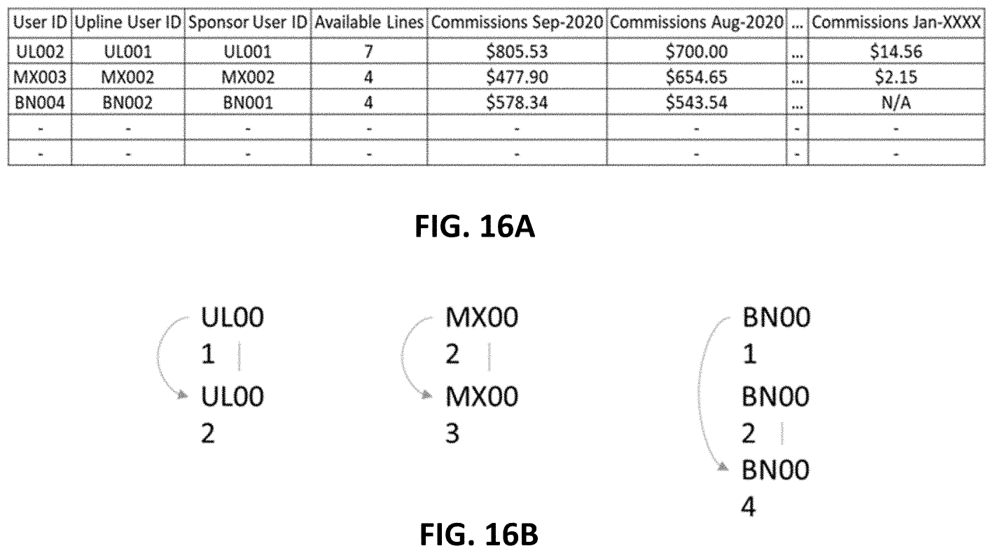

FIG. 16A illustrates an exemplary merged MLM merged user database 142. The merged MLM merged user database 142 includes a user ID (e.g., UL002), information on user's position in the merged MLM 138 commission structure, the user ID of the user above them in the commission structure (e.g., UL001), who enrolled or sponsored the user in the merged MLM 138 or the original MLM that was merged into the merged MLM 138 (e.g., user ID UL001), how many lines the user is currently allowed (e.g., 7), and commission data for each user both pre-merger and post-merger (e.g., $805.53 for the month of September 2020). Users are assigned a default number of lines when they join the merged MLM 138. Users that were merged from another MLM (e.g., unilevel MLM 120) will come into the merged MLM 138 with at least the number of lines they had under their old MLM structure. In an embodiment, the default number of lines is 4.

FIG. 16B illustrates an exemplary merged MLM commission structure based on the data in FIG. 16A, wherein the straight lines indicate an upline/downline relationship between two users and a curved, arrowed line indicates that the user the arrow points to was sponsored by the user the line originates from, more lines and users may exist than are shown.

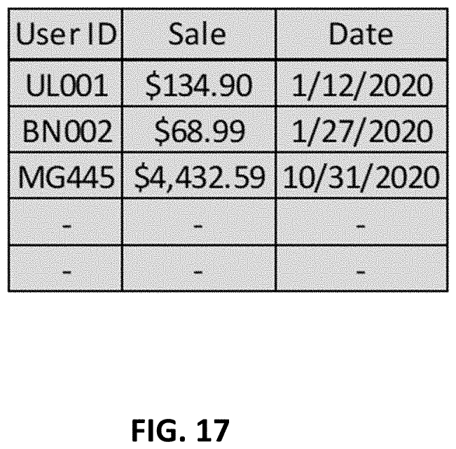

FIG. 17 illustrates an exemplary merged MLM simulated sales database 144. The merged MLM simulated sales database 144 includes example data on sales made by users, which includes a user ID (e.g., UL001), a sale value (e.g., $134.90), and a transaction date (e.g., Jan. 12, 2020), which is used by the merged MLM commission simulation module 146 to simulate commissions to be paid other users. In some embodiments, the database may include more sales data such as the seller's ID if applicable, item IDs of the items sold, volume sold, payment method and data, etc., and may include sales data from before the merger if the data is available. The example data is based on actual sale and may be a copy of real sales data or an estimate of real sales data. In another embodiment, the merged MLM simulated sales database 144 may be filled with completely random data. In some implementations, more than one merged MLM simulated sales database 144 may be used to eventually create a more robust commission rule.

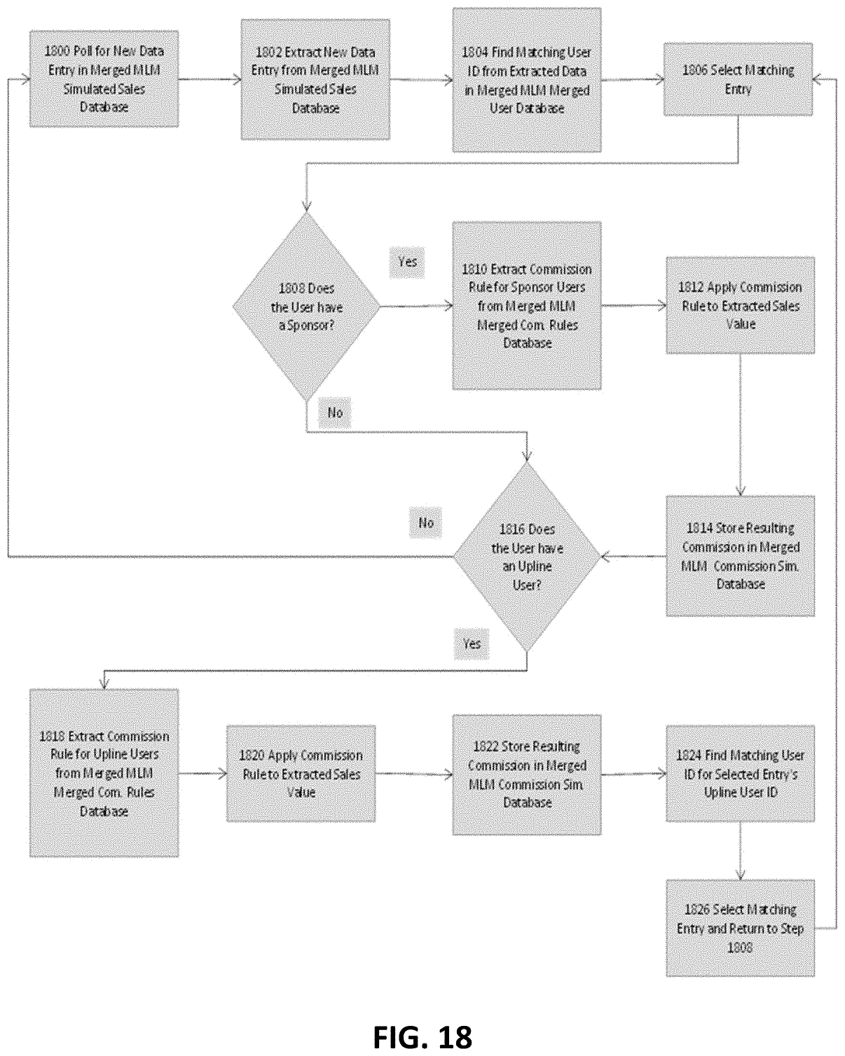

FIG. 18 illustrates an exemplary merged MLM commission simulation module 146. The process begins with the merged MLM commission simulation module 146 polling for a new data entry in the merged MLM simulated sales database 144 at step 1800.

The merged MLM commission simulation module 146 extracts the new data entry from the merged MLM simulated sales database 144 which includes at least a user ID, sales value, and date at step 1802.

The merged MLM commission simulation module 146 searches for a User ID in the merged MLM merged user database 142 that matches the user ID extracted from the merged MLM simulated sales database 144. For example, if the extracted user ID had a value of “UL002,” then the merged MLM commission simulation module 146 will search the merged MLM merged user database 142 for a value of “UL002” in the “User ID” category at step 1804.

The merged MLM commission simulation module 146 selects the entry in the merged MLM merged user database 142 with a matching user ID value at step 1806.

The merged MLM commission simulation module 146 determines if the user has a sponsor by checking the entry for a value in the “Sponsor User ID” category. If there is no value, or the value does not correspond to a user ID, then the merged MLM commission simulation module 146 will skip to step 1816 at step 1808.

If there is a value that corresponds to a user ID in the “Sponsor User ID” category, the merged MLM commission simulation module 146 extracts the commission rule from the merged MLM merged commission rules database 148 for sponsor users at step 1810.

At step 1812, the merged MLM commission simulation module 146 applies the extracted commission rule to the sales value extracted from the merged MLM simulated sales database 144. For example, if the rule is 10% commission for sponsors and the sales value is $300, then $300 will be multiplied by 10% to get $30, which is the commission payable to the sponsor.

At step 1814, the merged MLM commission simulation module 146 stores the resulting commission in the merged MLM commission simulation database 150 along with the user ID of the sponsoring user to be paid, the user ID of the sponsored user, the commission type (e.g., sponsor), and the date extracted from the merged MLM simulated sales database 144. In some embodiments, the date may be changed to reflect a delay in the processing of the commission or payment of the commission.

At step 1816, the merged MLM commission simulation module 146 determines if the user has an upline user by checking the entry for a value in the “Upline User ID” category. If there is no value or the value does not correspond to a user ID, then the merged MLM commission simulation module 146 will return to polling for a new data entry in the merged MLM simulated sales database 144.

If there is a value that corresponds to a user ID in the “Upline User ID” category, the merged MLM commission simulation module 146 extracts the commission rule from the merged MLM merged commission rules database 148 for upline users at step 1818.

At step 1820, the merged MLM commission simulation module 146 applies the extracted commission rule to the sales value extracted from the merged MLM simulated sales database 144. For example, if the rule is 10% commission for upline users and the sales value is $300, then $300 will be multiplied by 10% to get $30 which is the commission payable to the upline user. In some embodiments, users may receive a different commission based on how many levels upline they are from the user who made the sale. For example, the upline user of the upline user may earn 5% commission, and next upline user may earn 1% commission.

At step 1822, the merged MLM commission simulation module 146 stores the resulting commission in the merged MLM commission simulation database 150 along with the user ID of the upline user to be paid, the user ID of the downline user, the commission type (e.g., upline), and the date extracted from the merged MLM simulated sales database 144. In some embodiments, the date may be changed to reflect a delay in the processing of the commission or payment of the commission.

The merged MLM commission simulation module 146 then searches the merged MLM merged multiline user database 142 for an entry where the user ID in the “User ID” category matches the user ID in the “Upline User ID” category of the currently selected entry at step 1824.

The merged MLM commission simulation module 146 selects the entry with the matching user ID value as the new selected entry and returns to step 1808 at step 1826.

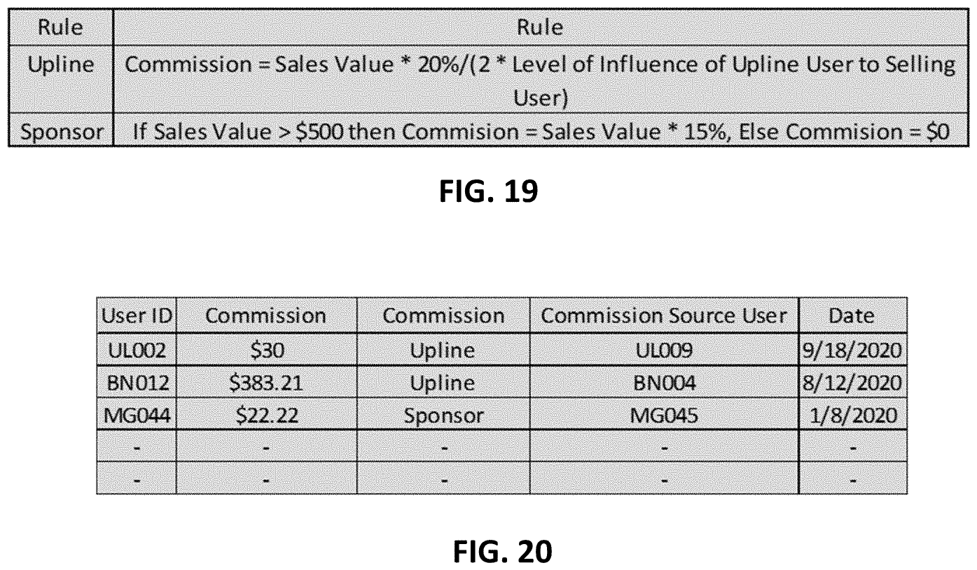

FIG. 19 illustrates an exemplary merged MLM merged com. rules database 148. The merged MLM merged commission rules database 148 includes commission rules which are used by the merged MLM commission simulation module 146 to determine commissions. Commission rules can be complex or simple, but will often involve a mathematical calculation. For example, a rule may dictate that commissions for upline users are 10% of the sales value, divided by two for each level above the selling user, meaning that for a $100 dollar sale, the upline user will receive $10; the user above them, or 2nd level of influence from the user who made the sale, will receive $5; the user above them will receive $2.50, etc. In another example, the rule may dictate that the commission for sponsors is 15% of the sale, but only if the sale is over $500; otherwise no commission is paid. The database also includes the type of rule (e.g., “Sponsor”), which indicates that the rule should be used to calculate commissions for sponsors. In some embodiments, multiple rules may exist for one rule type. For example, one rule may apply to sponsors that are also somewhere upline of the user who made the sale, while a different sponsor rule may apply if the sponsor is cross-line, meaning they are not anywhere upline of the user who made the sale.

FIG. 20 illustrates an exemplary merged MLM commission simulation database 150. The merged MLM commission simulation database 150 includes simulated commissions calculated by the merged MLM commission simulation module 146, which comprises at least a user ID (e.g., UL001), a commission value (e.g., $30), the type of commission (e.g., downline), the user ID of the user the commission came from (e.g., UL009), and a date (e.g., Sep. 18, 2020). If the commission came from a sale made somewhere in a user's downline, then the commission will be considered to come from the immediately downline user. In other embodiments, the commission may be recorded as coming from the selling user.

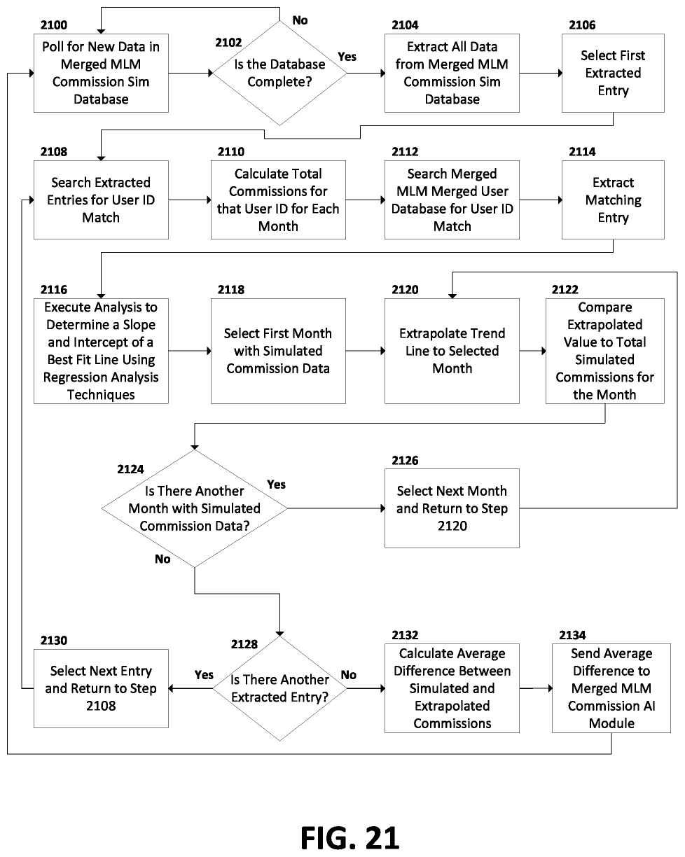

FIG. 21 illustrates an exemplary merged MLM commission comparison module 152. The process begins with the merged MLM commission comparison module 152 polling for new data in the merged MLM commission simulation database 150 at step 2100.

The merged MLM commission comparison module 152 determines if the database is complete by comparing the number of entries in the merged MLM commission simulation database 150 to the number of entries in the merged MLM simulated sales database 144. If the number is not equal, then the database is incomplete and the merged MLM commission comparison module 152 returns to polling for new data at step 2102.

If the database is complete, the merged MLM commission comparison module 152 extracts all data from the merged MLM commission simulation database 150 at step 2104.

The merged MLM commission comparison module 152 selects the first extracted entry at step 2106.

The merged MLM commission comparison module 152 searches the extracted entries for all entries that match the user ID of the selected entry in the “User ID” category at step 2108.

At step 2110, the merged MLM commission comparison module 152 calculates total commissions for the user ID for each month by adding together the commission value in the “Commission Value” category of each entry for entries that fall within the same month in the “Date” Category. An entry dated Jan. 17, 2020 and an entry dated Jan. 29, 2020 would be added to get the total commissions for January, but an entry dated Feb. 1, 2020 would not be added to the sum for January.

The merged MLM commission comparison module 152 searches the merged MLM merged user database 142 for an entry that matches in the “User ID” category the same user ID that was used to search the extracted data at step 2112.

The merged MLM commission comparison module 152 extracts the matching entry from the merged MLM merged user database 142 at step 2114.

At step 2116, the merged MLM commission comparison module 152 executes an analysis to determine a slope and intercept of a best fit line using regression analysis techniques from the historical commissions data of the extracted entry using a simple linear regression. In some embodiments, the trend line may be logarithmic, polynomial, exponential, moving average, any other type of trendline, or any combination of the preceding.

At step 2118, the merged MLM commission comparison module 152 selects the first month for which there is a simulated total commissions. This may not be the month immediately after the historical data ends and may also be a month that has already passed.

The merged MLM commission comparison module 152 extrapolates the trend line to the selected month by entering the selected month into the equation for the trend line, where the selected month is one for which historical data already exists the historical data will be used instead of the extrapolated value at step 2120.

At step 2122, the merged MLM commission comparison module 152 compares the extrapolated total commissions to the simulated total commissions for the selected month by subtracting the extrapolated commissions from the simulated commissions. In other embodiments comparison be done by another mathematical process such as dividing the simulated total by the extrapolated total.

The merged MLM commission comparison module 152 determines if there is another month for which there is a simulated total commissions at step 2124.

If there is another month for which there is a simulated total commissions, the merged MLM commission comparison module 152 selects the next month and returns to step 2120 at step 2126.

At step 2128, if there is not another month for which there is a simulated total commissions, the merged MLM commission comparison module 152 determines if there is another extracted entry with a user ID that has not been evaluated. Extracted entries that were returned by a user ID search are ignored since that user ID has already been evaluated.

If there is another extracted entry with a user ID that has not been evaluated, the merged MLM commission comparison module 152 selects the next entry and returns to step 2108 at step 2130.

At step 2132, if there is not another extracted entry with a user ID that has not been evaluated, the merged MLM commission comparison module 152 calculates the average difference between the simulated commissions and the extrapolated or actual commissions by summing up all the calculated differences for each user in a month and dividing by the number of users, then the average difference for each month is averaged by summing up all the average differences for each month and dividing by the number of months. In an embodiment, the average for each month is kept separate and not averaged. In some embodiments, different measures of the average may be used such as the median or mode. In some embodiments, other statistical information may be calculated from the data such as variance, standard deviation, range, interquartile range, etc.

The merged MLM commission comparison module 152 sends the calculated average difference for all users across all months to the merged MLM commission AI module 154 and returns to polling for new data in the merged MLM commission simulation database 150 at step 2134.

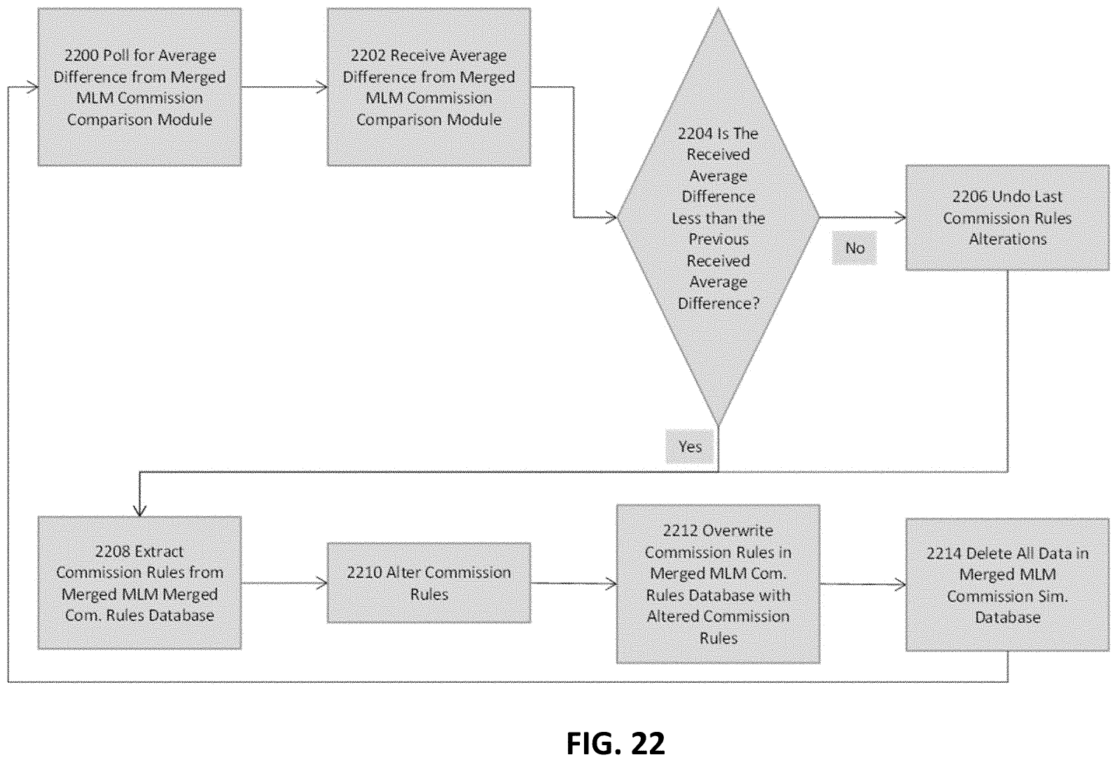

FIG. 22 illustrates an exemplary merged MLM commission AI module 154. The process begins with the merged MLM commission AI module 154 polling for the average difference between the simulated and the extrapolated or actual commissions from the merged MLM commission comparison module 152 at step 2200.

The merged MLM commission AI module 154 receives the average difference between the simulated and the extrapolated or actual commissions from the merged MLM commission comparison module 152 at step 2202.

At step 2204, the merged MLM commission AI module 154 determines if the average difference is less than the average difference previously received from the merged MLM commission comparison module 152. If this is the first time the merged MLM commission AI module 154 has received an average difference from the merged MLM commission comparison module 152, then skip to step 2208.

If the average difference is less than the average difference previously received from the merged MLM commission comparison module 152, the merged MLM commission AI module 154 undoes the alterations made in step 2210 from the previous time the merged MLM commission AI module 154 was run at step 2206.

At step 2208, the merged MLM commission AI module 154 extracts the commission rules from the merged MLM commission rules database 148. In some embodiments, only specific rule types may be extracted such as upline.

The merged MLM commission AI module 154 alters the commission rules by changing a preset variable within the rule. For example, the rule “Commission=Sales Value*20%/(2*Level of Influence of Upline User to Selling User)” may specify that the 20% may be a preset variable, the 2 may be a preset variable, and there may be invisible preset variables such as a 1 multiplying the sales value or an exponential 1 on the level of influence term. The altered rule may then specify, e.g., “Commission=Sales Value*25%/(2.01*Level of Influence of Upline User to Selling User)” or “Commission=0.95*Sales Value*20%/(2*Level of Influence of Upline User to Selling User)\hat{ }0.97”. In an embodiment, there may be no preset variables within the rule and the merged MLM commission AI module 154 may make random changes to the equation, and nonsensical equations will be discarded.

The merged MLM commission AI module 154 keeps track of these changes so that they may be undone on the next run if the changes do not decrease the average difference between the simulated commission and the extrapolated or actual commissions at step 2210.

The merged MLM commission AI module 154 overwrites the commission rule or rules in the 148 Merged MLM Com. Rules Database with the altered rule or rules at step 2212.

The merged MLM commission AI module 154 deletes all data in the merged MLM commission simulation database 150 so that the database can again be filled by using the newly altered commission rule, then returns to polling for the average difference between the simulated and the extrapolated or actual commissions from the merged MLM commission comparison module 152 at step 2214.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

1. (canceled)

2. A method for merging different user structures into a multiline user structure, the method comprising:
storing information in a database regarding at least a first user structure with a first set of lines corresponding to existing relationships, and a second user structure with a second set of lines corresponding to existing relationships;
receiving data for at least one member of the first user structure or the second user structure, wherein the data includes information regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure;
storing the merged multiline user structure in memory, wherein the merged multiline user structure is updatable to add one or more additional lines corresponding to new relationships with the at least one member;
creating simulated data based on the data; and
applying a learning algorithm to the simulated data to create a distribution plan for the new merged multiline user structure.

3. The method of claim 2, wherein the received data further includes a historical distribution of the at least one member over one or more periods of time.

4. The method of claim 3, further comprising retrieving a distribution rule from a database, wherein creating the simulated data includes generating a set of simulated distributions further based on the retrieved distribution rule.

5. The method of claim 4, further comprising:
determining a slope and an intercept of a trend line of the historical distribution of the at least one member; and
generating a set of extrapolated distribution based on the determined slope and the intercept of the trend line.

6. The method of claim 5, wherein applying the learning algorithm to the simulated data includes comparing the set of extrapolated distribution with the set of simulated distributions.

7. The method of claim 4, wherein applying the learning algorithm to the simulated data includes comparing the historical distribution with the set of simulated distribution.

8. The method of claim 4, wherein applying the learning algorithm to the simulated data further includes changing a preset variable within an algorithm of the retrieved distribution rule.

9. The method of claim 8, further comprising generating a new set of simulated distributions based on the changed preset variable within the algorithm of the retrieved distribution rule, and replacing the set of simulated distribution with the new set of simulated distribution in a database.

10. The method of claim 9, further comprising comparing the new set of simulated distributions to the historical distribution.

11. The method of claim 10, wherein the comparison includes determining that a difference between the set of simulated distributions and the historical distribution is less than a difference between the new set of simulated distributions and the historical distribution.

12. The method of claim 11, further comprising undoing a change to the preset variable based on the determined difference.

13. The method of claim 2, further comprising adding the additional lines to the merged multiline user structure based on threshold criteria being met by weighting one or more of the relationships between the at least one member and one or more members that are downline from the at least one member within the merged multiline user structure.

14. The method of claim 13, wherein adding the additional lines is based on online usage of a unique code associated with the at least one member, and wherein the unique code is an embedded uniform resource location (URL) of a webpage.

15. The method of claim 14, wherein the online usage of the unique code is at the webpage, and further comprising generating a new unique code based on the online usage of the unique code at the webpage by a device of a new member.

16. The method of claim 15, further comprising creating a new relationship between the new member and the at least one member within the merged multiline user structure, and storing information regarding the new relationship in association with the new unique code.

17. The method of claim 14, further comprising identifying one or more relationships with one or more members that are upline from the at least one member within the merged multiline user structure based on the data for the at least one member.

18. The method of claim 17, further comprising associating the at least one member and the upline members with an online interaction based on usage of the unique code during the online interaction.

19. A system for merging at least two multi-level user structures into a multiline user structure, the system comprising:
a first database that stores information regarding a first user structure with a first set of lines corresponding to existing relationships;
a second database that stores information regarding a second user structure with a second set of lines corresponding to existing relationships;
a merger module in communication with the first database and the second database, wherein the merger module is executable by a processor to merge the first user structure and the second user structure by:
receiving data for at least one member of the first user structure or the second user structure, wherein the data includes information regarding at least a position of the at least one member within the respective user structure and corresponding to a set of relationships of the at least one member; and
creating a new merged multiline user structure that includes at least one member, wherein the set of relationships of the at least one member is integrated into and maintained within the merged multiline user structure;
a multiline database that stores the merged multiline user structure in memory, wherein the merged multiline user structure is updateable to add one or more additional lines corresponding to new relationships with the at least one member; and
a simulation module that creates simulated data based on the data and applies a learning algorithm to the simulated data to create a commission plan for the new merged multiline user structure.

20. A non-transitory, computer-readable storage medium, having embodied thereon a program executable by a processor to perform a method for merging at least two multi-level user structures into a multiline user structure, the method comprising:
storing information in a database regarding at least a first user structure with a first set of lines corresponding to existing relationships, and a second user structure with a second set of lines corresponding to existing relationships;
receiving data for at least one member of the first user structure or the second user structure, wherein the data includes information regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure;
storing the merged multiline user structure in memory, wherein the merged multiline user structure is updatable to add one or more additional lines corresponding to new relationships with the at least one member;
creating simulated data based on the data; and
applying a learning algorithm to the simulated data to create a commission plan for the new merged multiline user structure.
